(19) United States
(12) Patent Application Publication
(10) Pub. No.: US 2016/0312468 A1
(43) Pub. Date: Oct. 27, 2016

(54) INORGANIC TRANSLUCENT MATERIAL

(71) Applicant: ROMASTONE CO., LTD., Taoyuan (TW)

(72) Inventors: PO LUNG LU, TAOYUAN (TW); HUNG CHIEH CHIEN, TAOYUAN (TW); CHIEN HUA CHANG, TAOYUAN (TW)

(21) Appl. No.: 14/691,651

(22) Filed: Apr. 21, 2015

(51) Int. Cl. E04C 2/52; C04B 14/48; C04B 14/00

(52) U.S. Cl. CPC E04C 2/526; C04B 14/005; C04B 14/48; E04C 2002/005

(57) ABSTRACT

An inorganic translucent material includes an inorganic body made of inorganic material. A plurality of inorganic translucent members is pre-embedded in the inorganic body, and two ends of each of the inorganic translucent members are exposed from the surface of the inorganic body, such that the light can pass through the inorganic translucent members so as to provide a light transmittable visual verisimilitude. The inorganic body further includes a plurality of metal enforcing materials assembled therein to improve the structural strength of the inorganic body.

### BACKGROUND OF THE INVENTION

1. Field of the Invention

The present invention relates to an inorganic architecture, and more particularly to an inorganic material embedded with translucent members.

2. Description of the Prior Art

Inorganic materials, like concretes, are common building materials provided for establishing the main structure of a building or the decorations on a building. To perform a better decoration, translucent aggregates 5 are provided onto an inorganic material 4, as shown in FIG. 14. Therefore, when light illuminates the inorganic material 4 with aggregates, the light would pass through or be reflect by the inorganic material 4, such that the inorganic material 4 with aggregates can present a different visual verisimilitude as compared with a naked inorganic material.

However, since the translucent aggregates 5 are spread onto the surface of the inorganic material 4, the conventional material can only perform a single translucent result and can hardly perform various visual verisimilitudes. Further, since the inorganic material 4 and the translucent aggregates 5 are made of different materials, when the translucent aggregates 5 are merely secured onto the surface of the inorganic material 4, the overall structural strength of the conventional material would be insufficient to suffer foreign forces induced from strong winds or severe quakes, and the conventional material would be damaged easily.

The present invention is, therefore, arisen to obviate or at least mitigate the above mentioned disadvantages.

### SUMMARY OF THE INVENTION

One object of the present invention is to provide an inorganic translucent material pre-embedded with a plurality of inorganic translucent members so that light can pass through the inorganic translucent material through the inorganic translucent members.

A further object of the present invention is to provide an inorganic translucent material having a plurality of inorganic translucent members therein and a plurality of metal enforcing materials formed as meshes so as to improve the structural strength.

To achieve the above and other objects, an inorganic translucent material is provided and comprises an inorganic body, a plurality of inorganic translucent members, and a plurality of metal enforcing materials. The inorganic body is made of inorganic material. The inorganic translucent members are pre-embedded in the inorganic body, and two ends of each of the inorganic translucent members are exposed from the surface of the inorganic body. The metal enforcing materials are assembled in the inorganic body. The metal enforcing materials are extending along a direction. Alternatively, the metal enforcing materials may be aligned along the length direction or the width direction of the inorganic body. Or, the metal enforcing materials may be aligned along a tilting direction. Furthermore, the metal enforcing materials may be formed as meshes.

Specifically, the inorganic body is divided into an upper portion and a lower portion, and the metal enforcing materials are assembled to the upper portion and the lower portion. Moreover, the configurations and the extending directions of the metal enforcing materials assembled in the upper portion is the same as those of the metal enforcing materials assembled in the lower portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 illustrates a perspective view of a first embodiment of an inorganic translucent material according to the present invention;

FIG. 2 illustrates a sectional view along line a-a shown in FIG. 1;

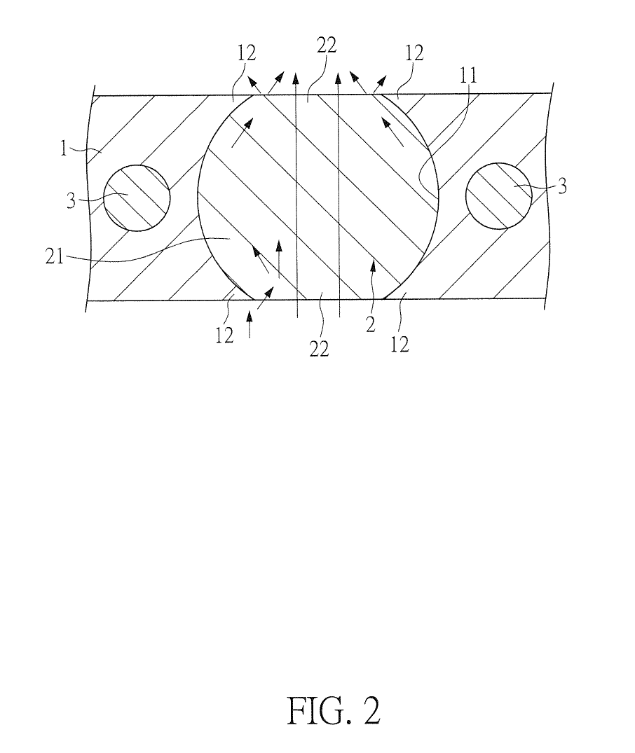

FIG. 3 illustrates a sectional view along line a-a shown in FIG. 1, for one variation;

FIG. 4 illustrates a sectional view along line A-A shown in FIG. 1;

FIG. 5 illustrates a perspective view of a second embodiment of an inorganic translucent material according to the present invention;

FIG. 6 illustrates a sectional view along line b-b shown in FIG. 5;

FIG. 7 illustrates a sectional view along line B-B or along line C-C shown in FIG. 5;

FIG. 8 illustrates a perspective view of a third embodiment of an inorganic translucent material according to the present invention;

FIG. 9 illustrates a sectional view along line D-D or along line E-E shown in FIG. 8;

FIG. 10 illustrates a perspective view of a four embodiment of an inorganic translucent material according to the present invention;

FIG. 11 illustrates a sectional view along line F-F or along line G-G shown in FIG. 10;

FIG. 12 illustrates a perspective view of a fifth embodiment of an inorganic translucent material according to the present invention;

FIG. 13 illustrates a sectional view along line H-H or along line I-I shown in FIG. 12; and

FIG. 14 illustrates a perspective view of a conventional inorganic material structure.

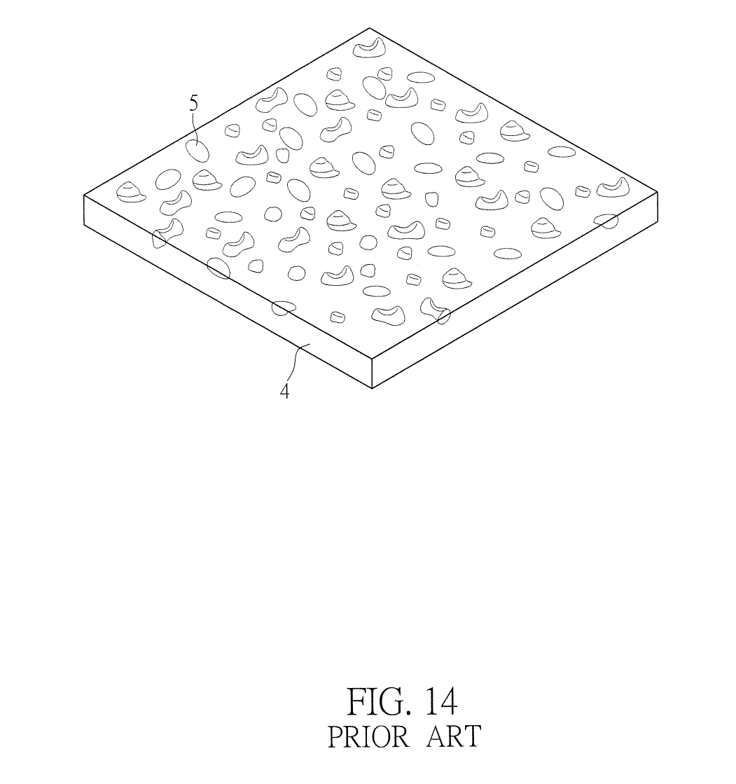

### DETAILED DESCRIPTION OF THE PREFERRED EMBODIMENTS

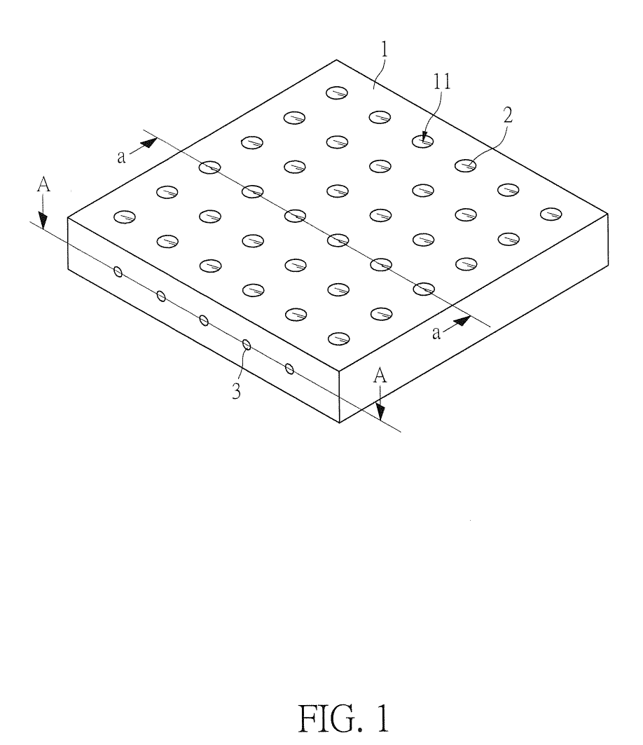

Please refer to FIG. 1, illustrating a first exemplary embodiment of an inorganic translucent material according to the present invention. The inorganic translucent material comprises an inorganic body 1 made of inorganic material. In this embodiment, the inorganic body 1 is formed as a rectangular plate and as a unit member. In practice, several unit members may be assembled with each other to form an integrated member. A plurality of inorganic translucent members 2 is pre-embedded in the inorganic body 1. In this embodiment, the inorganic translucent members 2 are made of glass for light transmission. Further, the inorganic translucent members 2 can be dyed to have different colors, so that different visual verisimilitudes can be performed when light passes through the dyed inorganic translucent members 2.

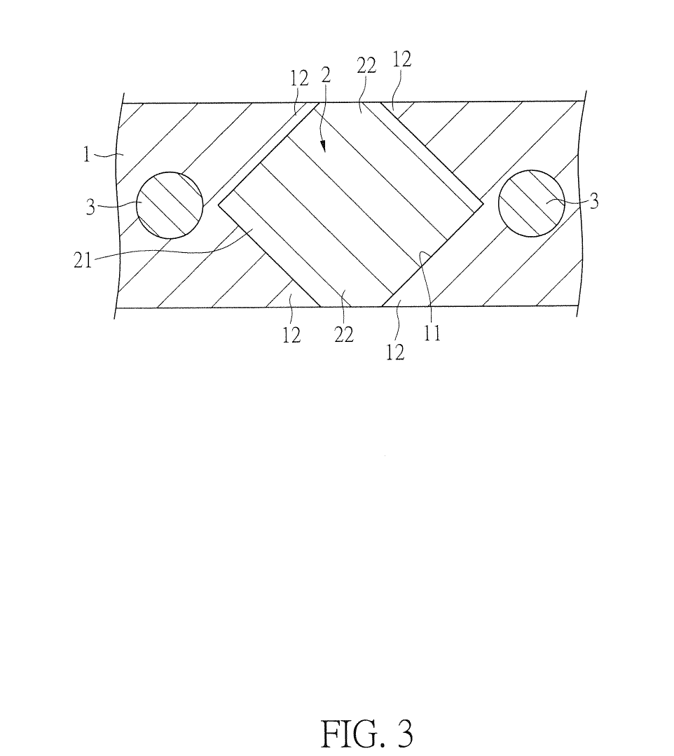

Each of the inorganic translucent members 2 comprises a middle portion 21 and two end portions 22 respectively extending from two ends of the middle portion 21, and for each inorganic translucent member 2, the width of each of the two end portions 22 is less than the width of the middle portion 21. In this embodiment, the inorganic translucent members 2 are ball shaped. In some embodiments, the inorganic translucent members 2 are hexahedron shaped, as shown in FIG. 3. In some embodiments, the inorganic translucent members 2 may be of other shapes. On the other hand, the inorganic translucent members 2 are embedded in the inorganic body 1 so as to define a plurality of holes 11 at the inorganic body 1, where the holes 11 correspond to the shapes of the inorganic translucent members 2. That is, for each hole 11, the width is gradually reduced, from the middle to the two ends. For each inorganic translucent member 2, the two end portions 22 are exposed from the surface of the inorganic body 1, and the surface of the inorganic translucent member 2 is aligned with the surface of the inorganic body 1. Alternatively, in some embodiments, the two end portions 22 may be protruded from the surface of the inorganic body 1. Accordingly, two inorganic translucent portions 12 are defined at two opposite sides of each of the holes 11, and the thickness of the inorganic translucent portion 12 is less than the depth of the hole 11.

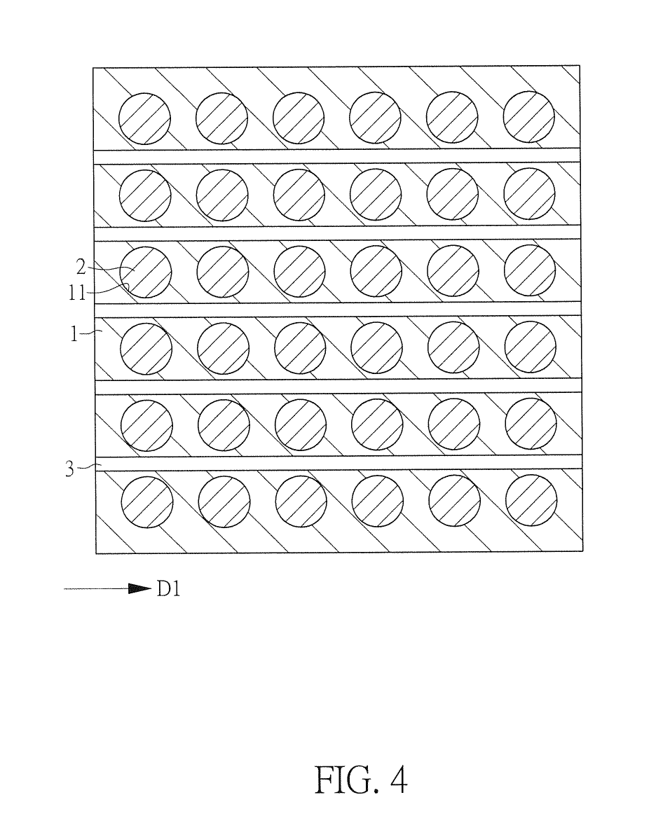

In addition, the inorganic body 1 has a plurality of metal enforcing materials 3 assembled therein. As shown in FIG. 4, an exemplary embodiment of the inorganic body 1 with metal enforcing materials 3 is illustrated. In this embodiment, one line of the metal enforcing materials 3 is configured in the inorganic body 1. Each of the metal enforcing materials 3 is sandwiched between two lines of inorganic translucent members 2, and the metal enforcing materials 3 are unidirectional, extending a long a first direction D1, where the first direction D1 is the length direction of the inorganic body 1. Accordingly, the metal enforcing materials 3 can effectively improve the structural strength of the inorganic body 1.

The manufacturing method of the inorganic translucent material is described as below. The inorganic body 1 is formed by pouring a mixed material having lime muds and inorganic aggregates into a mold and solidifying the material in the mold.

Wherein, prior to the molding procedure, the inorganic translucent members 2, ball shaped, hexahedral, or other shaped, are pre-embedded in preset positions of the mold, and the metal enforcing materials 3 are prearranged with preset directions in the mold. Accordingly, an inorganic plate with arranged metal enforcing materials 3 and embedded inorganic translucent members 2 can be formed. Next, the two surfaces of inorganic plate are polished and cutting. Specifically, the inorganic plate is polished and cut until the end portions 22 of each of the inorganic translucent members 2 are exposed from the surface of the inorganic plate. Accordingly, the inorganic translucent material can be manufactured based on the described method.

In the present invention, light can directly pass through the inorganic translucent members 2 and be emitted out from the holes 11 so as to generate a light transmittable visual verisimilitude. Furthermore, the inorganic translucent portions 12 allows light to be scattered so that vogue halos are generated among the circumferential edges of the holes 11 so as to improve the decorative performance of the inorganic translucent material. In detail, when light are directed to the inorganic translucent portions 12, the inorganic translucent portions 12 cannot perfectly shield the light from penetrating the inorganic translucent material due to thinner thicknesses of the inorganic translucent portions 12, and the light would be scattered around from the inorganic translucent portions 12. Therefore, halos are formed at the circumferential edges of the holes 11.

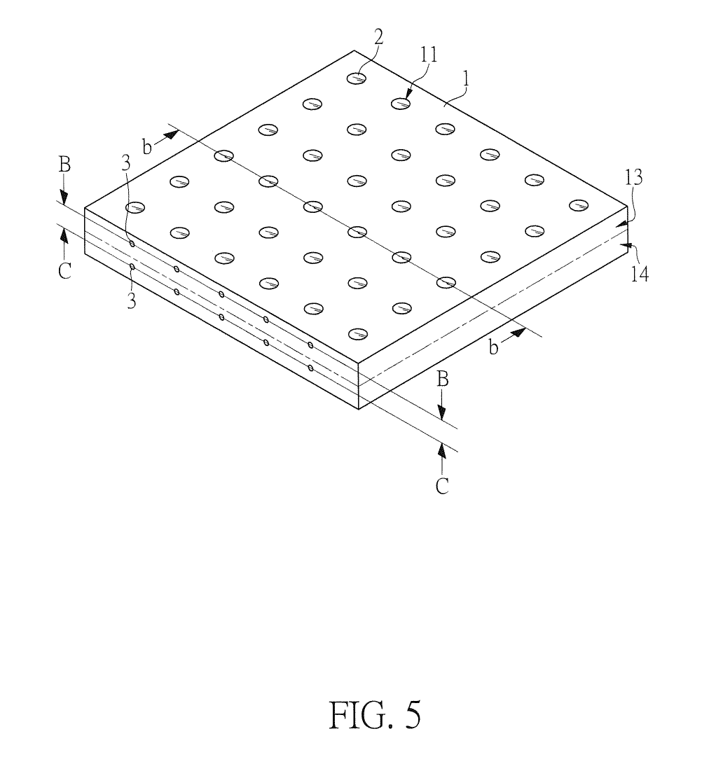

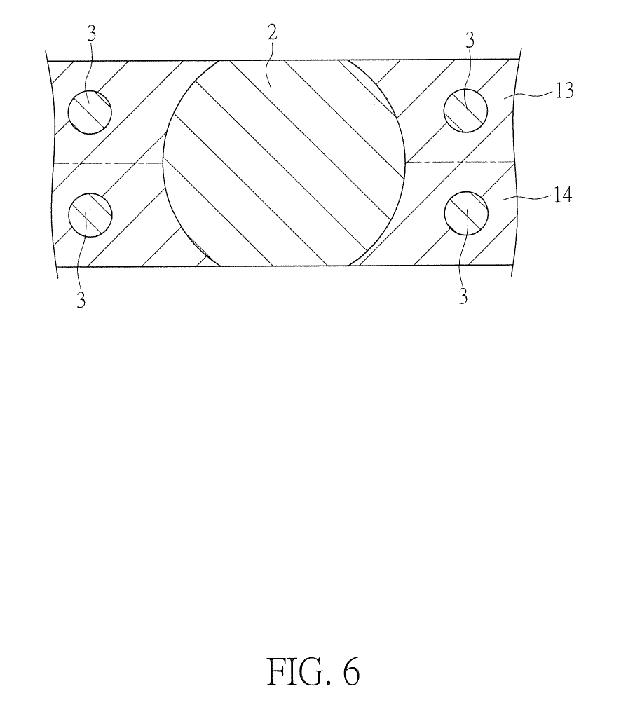

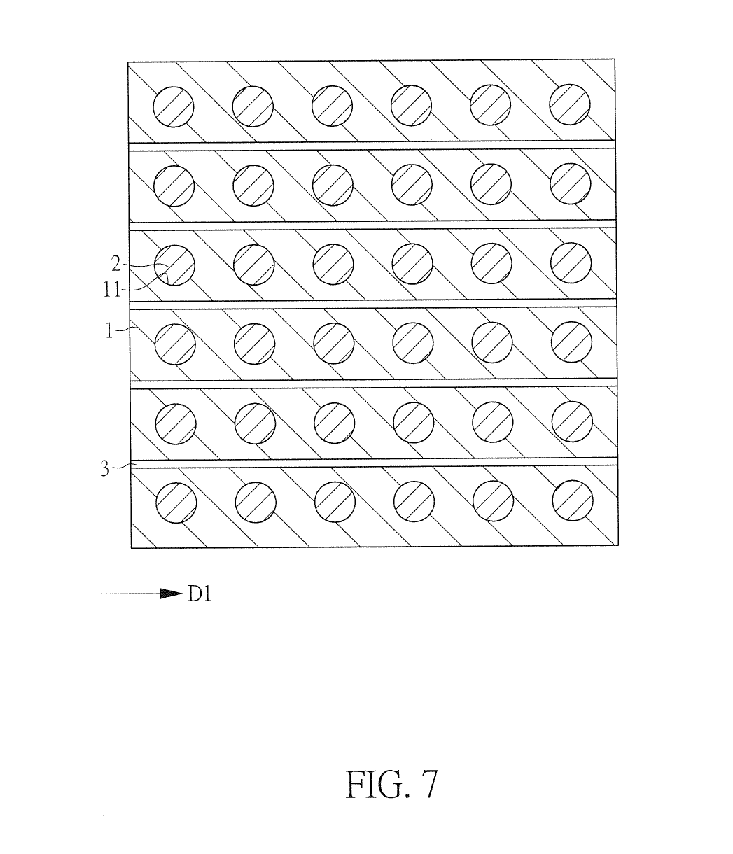

FIG. 5 and FIG. 6 illustrate a second embodiment of an inorganic translucent material according to the present invention. The structure of the second embodiment is approximately the same as that of the first embodiment, except the number of the lines of the metal enforcing materials 3 and the directions where the metal enforcing materials 3 are directed to. In the second embodiment, two lines of metal enforcing materials 3 (upper line and lower line) are configured in the inorganic body 1. In this embodiment, the inorganic body 1 is further divided into an upper portion 13 and a lower portion 14, and the metal enforcing materials 3 are assembled in the upper portion 13 and the lower portion 14. As shown in FIG. 7, the metal enforcing materials 3 assembled in the upper portion 13 and the metal enforcing materials 3 assembled in the lower portion 14 are both aligned along the first direction D1, such that the structure strength of the inorganic body 1 is further improved.

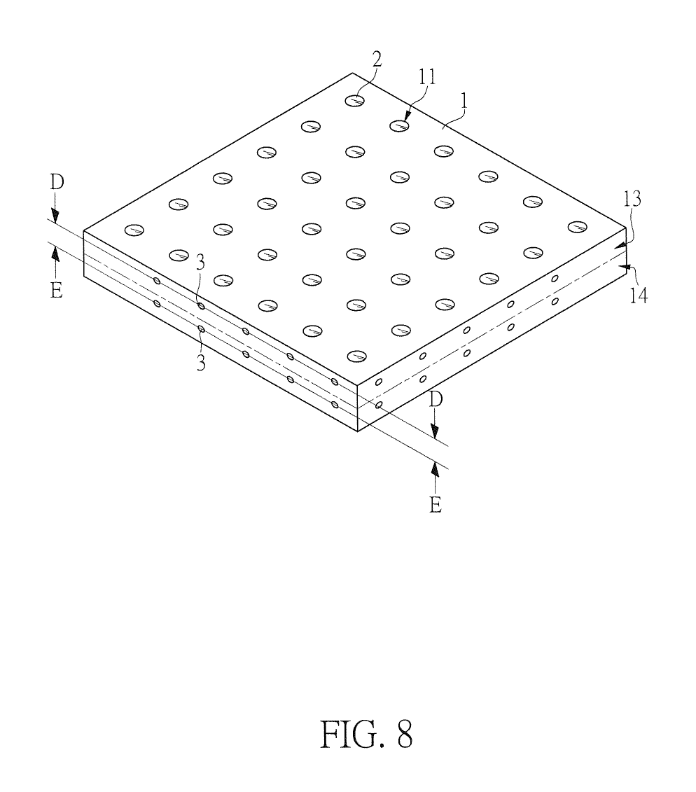

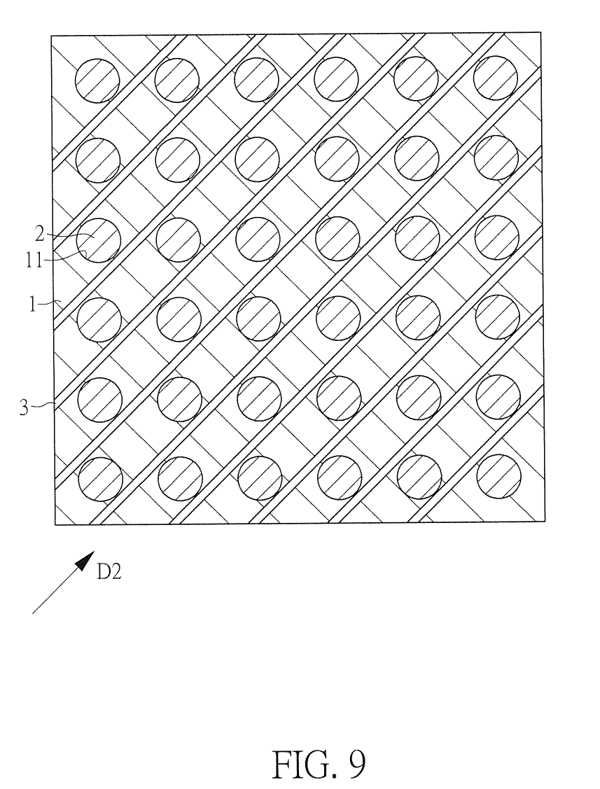

FIG. 8 and FIG. 9 illustrate a third embodiment of an inorganic translucent material according to the present invention. The structure of the third embodiment is approximately the same as that of the second embodiment, except the direction of the metal enforcing materials 3. Specifically, as shown in FIG. 9, the metal enforcing materials 3 assembled in the upper portion 13 and the metal enforcing materials 3 assembled in the lower portion 14 are aligned along a second direction D2 which is tilted from the length direction of the inorganic body 1 and also tilted from the width direction of the inorganic body 1, so that the structure strength of the inorganic body 1 is further improved.

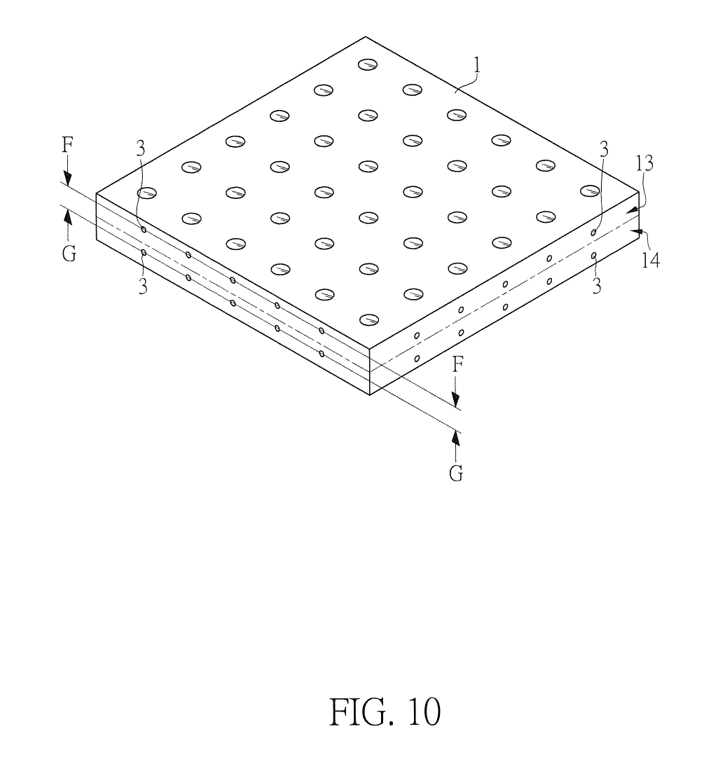

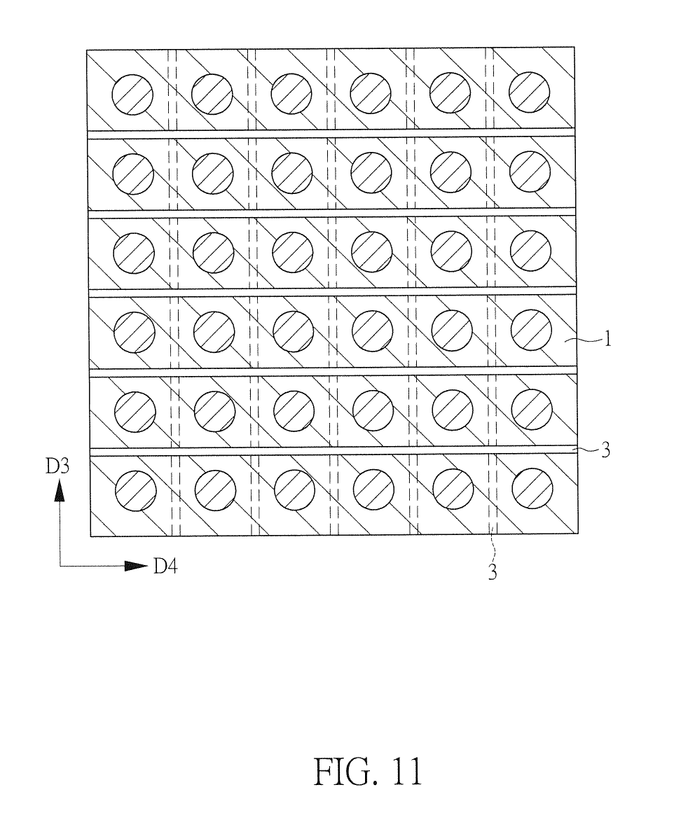

FIG. 10 and FIG. 11 illustrate a fourth embodiment of an inorganic translucent material according to the present invention. The structure of the fourth embodiment is approximately the same as that of the second embodiment, except the direction of the metal enforcing materials 3. Specifically, as shown in FIG. 11, both the metal enforcing materials 3 assembled in the upper portion 13 and the metal enforcing materials 3 assembled in the lower portion 14 are aligned along the length direction D3 and the width direction D4 of the inorganic body 1, such that the metal enforcing materials 3 assembled in the upper portion 13 would be formed as a mesh pattern, the metal enforcing materials 3 assembled in the lower portion 14 would be formed as another mesh pattern, and the two mesh patterns are symmetrical with each other. Accordingly, the structural strength of the inorganic body 1 is further improved.

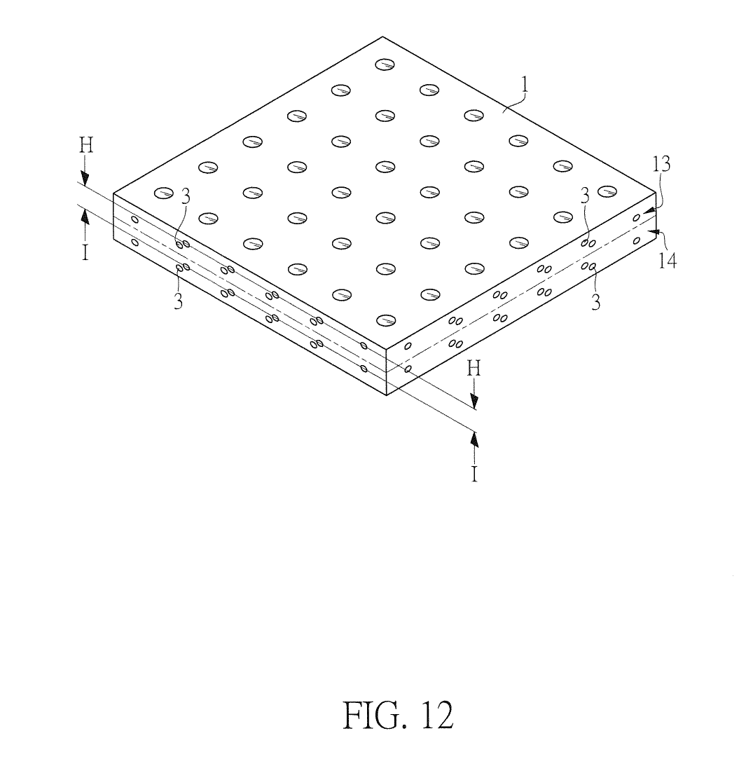

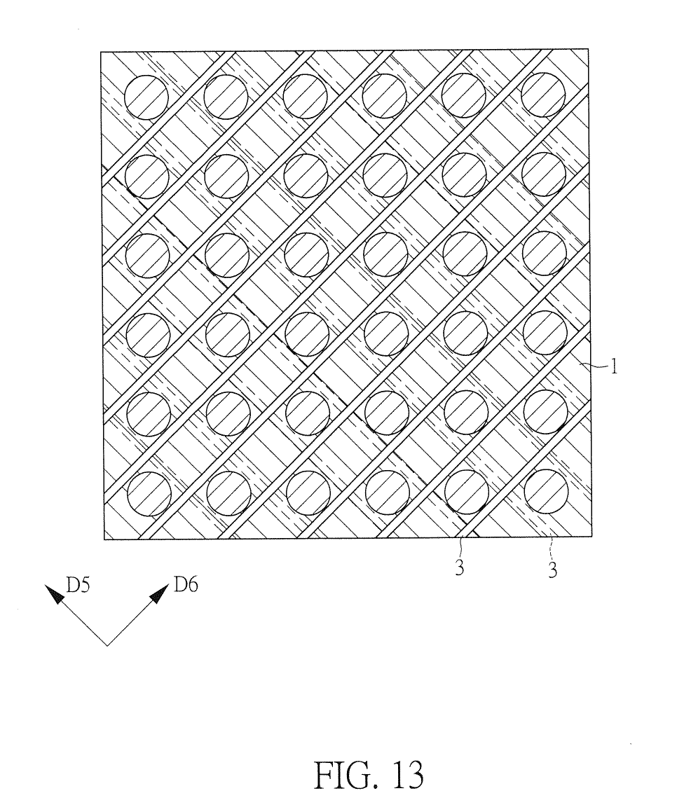

FIG. 12 and FIG. 13 illustrate a fifth embodiment of an inorganic translucent material according to the present invention. The structure of the fifth embodiment is approximately the same as that of the third embodiment, except the direction of the metal enforcing materials 3. Specifically, as shown in FIG. 13, both the metal enforcing materials 3 assembled in the upper portion 13 and the metal enforcing materials 3 assembled in the lower portion 14 are aligned along the a first tilting direction D5 and a second tilting direction D6 of the inorganic body 1, where the first tilting direction D5 is substantially perpendicular to the second tiling direction D6, such that the metal enforcing materials 3 assembled in the upper portion 13 would be formed as a mesh pattern, the metal enforcing materials 3 assembled in the lower portion 14 would be formed as another mesh pattern, and the two mesh patterns are symmetrical with each other. Accordingly, the structural strength of the inorganic body 1 is further improved.

However, the disclosure about the aforementioned embodiments is provided to describe the present invention, rather than to limit the scope of the present invention.

Although particular embodiments of the invention have been described in detail for purposes of illustration, various modifications and enhancements may be made without departing from the spirit and scope of the invention. Accordingly, the invention is not to be limited except as by the appended claims.

1. An inorganic translucent material, comprising:
an inorganic body made of inorganic material;
a plurality of inorganic translucent members pre-embedded in the inorganic body, wherein two ends of each of the inorganic translucent members are exposed from the surface of the inorganic body; and
a plurality of metal enforcing materials assembled in the inorganic body, wherein the metal enforcing materials are extending along at least one direction.

2. The inorganic translucent material according to claim 1, wherein the inorganic translucent members are pre-embedded in the inorganic body so as to define a plurality of holes at the inorganic body, wherein two inorganic translucent portions are defined at two opposite sides of each of the holes, and the thickness of the inorganic translucent portion is less than the depth of the hole.

3. The inorganic translucent material according to claim 1, wherein the inorganic translucent members are colored or uncolored.

4. The inorganic translucent material according to claim 1, wherein each of the inorganic translucent members comprises a middle portion and two end portions respectively extending from two ends of the middle portion, and wherein the width of each of the two end portions is less than the width of the middle portion.

5. The inorganic translucent material according to claim 4, wherein the inorganic translucent members are ball shaped or hexahedron shaped.

6. The inorganic translucent material according to claim 1, where the inorganic body is divided into an upper portion and a lower portion, and wherein the metal enforcing materials are assembled to the upper portion and the lower portion.
